(19) United States
(12) Patent Application Publication
(10) Pub. No.: US 2020/0307941 A1
(43) Pub. Date: Oct. 1, 2020

(54) TAPE LENGTH TAPE DISPENSER

(71) Applicant: LAMUS TECHNOLOGIES INC., VANCOUVER (CA)

(72) Inventors: JOE AUGUSTINE S.T. LAM, VANCOUVER (CA); JASON Y-WAN CHENG, BURNABY (CA)

(21) Appl. No.: 16/366,019

(22) Filed: Mar. 27, 2019

(51) Int. Cl. B65H 35/00; G01B 11/02

(52) U.S. Cl. CPC B65H 35/0066; B65H 2511/11; G01B 11/02; B65H 35/0073

(57) ABSTRACT

An apparatus for dispensing a pre-determined cut length of tape that includes a tape dispensing system that includes a tape dispenser, a scaling sensor that determines the length of a box or object to which the cut length of tape is to be applied and a control system including a processor processing signals from the scaling sensor to determine the length of the cut length of tape to be dispensed and controlling the dispenser to dispense the required length of tape.

### CROSS REFERENCE TO RELATED APPLICATIONS

Not Applicable.

### STATEMENT REGARDING FEDERALLY SPONSORED RESEARCH OR DEVELOPMENT

Not Applicable

### REFERENCE TO MICROFICHE APPENDIX

Not Applicable.

### FIELD OF INVENTION

The present invention relates to a tape dispensing system, more particularly to a tape dispensing system wherein the output tape length of a dispenser is adjusted to dispense a defined length of tape based on a scaling sensor sensing the dimension of the article to which the dispensed tape is to be applied.

### BACKGROUND OF THE PRESENT INVENTION

The amount of on-line sales is expanding exponentially and orders so sold must, in many cases each be individually packaged and shipped to the buyer. This poses a totally different packaging situation to the heretofore convention packaging systems wherein a plurality of essentially the same size cartons are presented to the machine in a substantially constant stream and these cartons are closed and sealed by an automatic packaging machine processing many, many, cartons per minute.

Based on current technology individual cartons as required, for example, with on-line sales are in most cases sealed manually. There are many different manual tapers used to apply tapes to seal cartons or cases, most simply rely on a dispenser and an operation in which the operator manually manipulates the applicator to dispense and apply the leading end of a tape to the carton then the operator moves the dispenser relative to the carton to apply the tape to the closed flaps of the case and finally manipulates the dispenser to apply the tape to an end wall of the case or carton and cut the tape after application has substantially been completed.

In another system uses a tape dispenser wherein the operator inputs the required tape length to a dispenser which may be manually or power driven to dispense the inputted tape length which the operator then applies to the carton to seal same. Such a dispenser is shown in U.S. Pat. No. 9,926,166 issued Mar. 17, 2018 to Lazzaaroni which shows a tape wetting dispenser for dispensing a pre-selected length of tape. Similar dispensers are sold under the trade name “Tapeshooter” and are designed to dispense two sided tapes i.e. tapes having say a pressure sensitive adhesive on one side; see for example, PCT published application WO 00/41960 published Jul. 20, 2000.

Tape dispensers that dispense preset tape lengths using a driven feed roller for a time required to dispense the desired length of tape see for example US2016353945 published Dec. 8, 2016 and US20020121169 published Sep. 2, 2002 and U.S. Pat. No. 3,076,587.

### BRIEF DESCRIPTION OF THE PRESENT INVENTION

The present invention provides a tape dispensing system and method of taping that greatly facilitates and permits an operator to more quickly seal a carton or case by permitting the operator to quickly and easily measure or scale the object to which the tape is to be applied and in the course of measuring define a required tape length and control a tape dispenser to dispense the required tape length. The so set and dispensed tape length may then manually be applied to the object such as a case or carton.

Broadly the present invention relates to a tape dispensing system comprising a tape dispenser, a scaling sensor to determine a dimension of an object to which a length of tape is to be applied said scaling sensor generating scaling signals used to determine said dimension of said object, a control system including a processor processing said scaling signals to determine a tape length to be dispensed and controlling said dispenser to actuate said tape dispenser and dispense said tape length.

Preferably said scaling sensor comprises a support bar mounting a plurality of uniformly spaced interconnected proximity sensors connected to said control system to generate said scaling signal.

Preferably each said proximity sensor includes a signal emitter emitting a proximity signal and a receiver for receiving said proximity signal, said signal emitter and said receiver being relatively positioned so that said receiver receives said proximity signal when it is reflected from an adjacent surface of said object when said object is moved into sensing range of said proximity sensor.

Preferably said proximity signal is an infrared light and said receiver is an infrared sensor.

Preferably said support bar comprises at least one special sensor having an additional function to when activated add additional length to said tape length.

Preferably said scaling sensor further includes a second scaling sensor perpendicular to said scaling sensor for determining a second dimension of said object.

Preferably said processor is programed to start scanning when at more than one of said sensors have been actuated and to perform the multiple scans, review the outputs of all said sensors to obtain a stable measurement reading based on a plurality of consecutive scans and register such measurement as a confirmed measurement output signal to activate the tape dispenser.

Preferably said support bar comprises at least one special sensor having an additional function to when activated add additional length to said tape length.

Preferably said scaling sensor further includes a second scaling sensor perpendicular to said scaling sensor for determining a second dimension of said object.

### BRIEF DESCRIPTION OF THE SEVERAL VIEWS OF THE DRAWINGS

Further features, objects and advantages will be evident from the following detailed description of the preferred embodiments of the present invention taken in conjunction with the accompanying drawings in which;

FIG. 1 is a schematic isometric view of a tape dispensing system of the present invention with parts omitted shown a scaling sensor that measures a dimension of an object (box or carton shown) to which the tape is to be applied and the controls a tape dispenser to dispense a length of tape based on the measured dimension.

FIG. 2 is a plan view of the scaling sensor and box showing the application of a tape applied to hold the opposed closure flaps in sealed position and extending along the longitudinal centerline of the box and with tape tabs projecting beyond the end walls of the box in position to be wiped against the adjacent end wall of the box (i.e. a tape length longer that the sensed box length).

FIG. 3 is a view similar to FIG. 2 showing a transversely extending tape the same length as the width of the box applied to the closure flaps adjacent to one end of the box and with about ½ of the width of the tape extending beyond the end wall and in position to be wiped onto the adjacent end wall of the box.

FIGS. 4 is a view similar to FIG. 1 but showing a second tape dispensing system employing mutually perpendicular scaling sensors to provide a system that can measure 2 mutually perpendicular dimensions of an object (box) without turning the box or object 90° in sequence and a box with tapes applied longitudinally along the center of the box and transversely adjacent to each end of a box to seal the top flaps closed.

FIGS. 5 and 6 are similar to FIGS. 2 and 3 but show the use of the tape dispensing system of FIG. 4 to provide a tape length for application longitudinally and a second transverse to the box.

FIG. 7 is a block diagram of the scaling system (single scaler) and the manner in which it engages with the article being sensed and controls the length of tape dispensed by the tape dispenser.

### DETAILED DESCRIPTION OF THE INVENTION

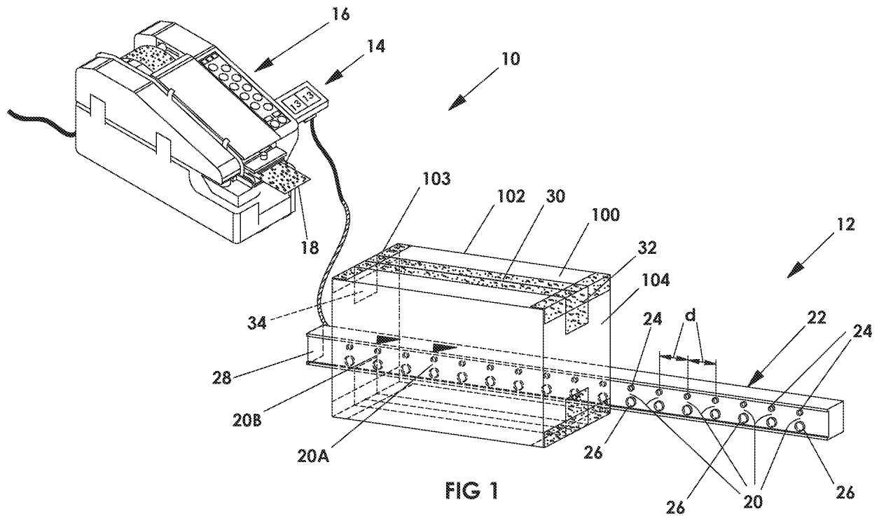

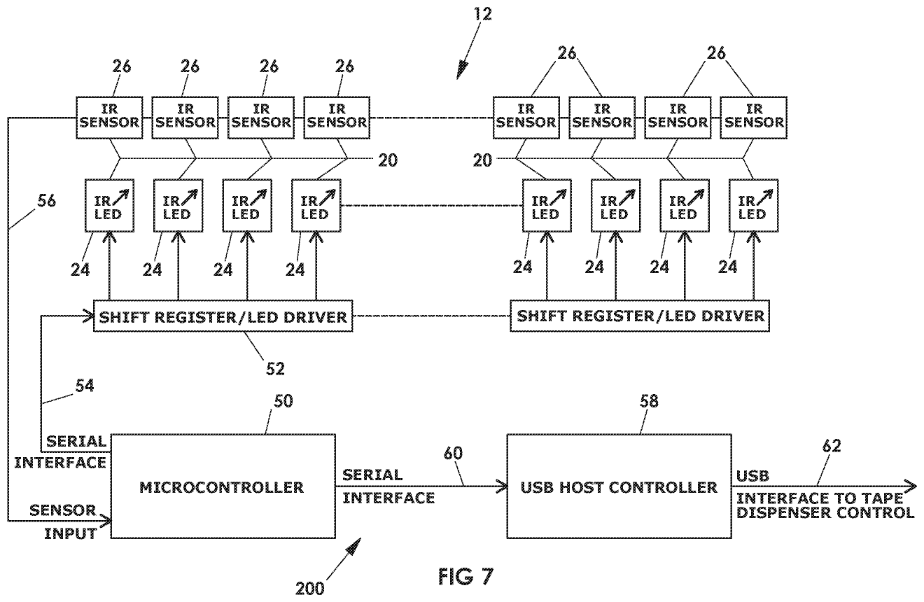

The present invention as shown in FIG. 1 is a tape dispensing system 10 for dispensing predefined tape lengths based on signals generated by a scaling sensor 12 that, as will be described in more detail with reference to FIG. 7, generates signals that are process by the computer processor 14 and used to control the operation of the tape dispenser 16 to dispense tape 18 of a length based on the signals from the scaling sensor 12. The processor 14 is shown in FIG. 1 and as mounted on the dispenser 16 but it may be located in any suitable location for example on the scaler 12.

The dispenser 16 may be any suitable dispenser for example those sold under the tradename “Tapeshooter” referred to above and suitably modified to properly interact with the processer 14.

The scaling sensor may be any suitable sensor to determine the length of the object to which the tape is to be applied and used to generate the required signals to be processed by processor 14 and control the dispenser 16 as required. The preferred system incorporates a plurality of proximity sensors 20 (only those extending beyond the box not all have been identified with the numeral 20) uniformly spaced along the length of a support or mounting bar 22. The distance between adjacent sensors 20 will normally be the same between all adjacent sensors 20 has been indicated as dimension d in FIG. 1 and preferably will be between 0.5 inch and 1 inch.

In the illustrated arrangement each such proximity sensor an infrared (IR) sensor is composed of an IR signal emitter (light emitter) 24 and an IR signal receiver 26. Other suitable types of proximity sensors may be used. Each pair of emitter 24 and receiver 26 that combine to form a proximity sensor 20 are mounted on the bar 22 in a relative orientation so that when a surface being sensed is in sensing range of the proximity sensor 20 the emitted signal from the emitter 24 is reflected back to the receiver 26 to which it is paired to generate a scaling signal. The numeral 20 has not been connected to each of the sensors 20 on the bar only to those that are beyond the box 100 being scanned. In operation the number of sensors 20 that are activated when a box 100 is being scaled (or scanned) determines the output of the scaler 12 that represents the box length L (see FIG. 2) and the length of tape dispensed normally will correspond with length L (or width W as will be discussed below) or will be longer to provide tabs (32 and 334 discussed below) if tabs are to be used.

A special pair of proximity sensors designated 20A and 20B that are positioned adjacent to the end 28 of the support bar 22 have a dual function namely to sense the presence of the box and when activated to generate a second signal adding length to the tape to be dispensed to provide a tape length longer than the length L (or width W) of the box 100 sensed to provide a tape length 30 with end tabs 32 and 34 that are wiped down and adhered to the adjacent end wall 103 and 104 respectively of the box 100.

In FIG. 2 the tabs 34 and 32 have been shown with tab lengths T1 and T2 the combined length of which is equal to the added length applied by the scaler and the relative lengths of which will in effect be defined by the operator as he applies the tape 30 and normally will be substantially equal i.e.T1 will normally be the same length as T2. The actual total length of the tape dispensed as above indicated is determined by the number of proximity sensor 20 that detect the presence of the box 100 and if the special dual function proximity sensor 20A or sensors 20A and 20B detect the box, length is added to the length of tape dispensed to provide additional tape for the tabs 32 and 34. If only the special sensor 20A detects the presence of the box 100 a first additional length is added to the length L (see FIG. 2) of the box 100 determined by the scaling sensor 12 and if sensor 20B detects the box a second additional length is added to the length L of the box is case 100 determined by the scaling sensor 12. The first added length will normally be shorter than the second added length thereby permitting the operator to select the length T1 and T2 of tabs 32 and 34 most suited for the box being taped closed. Applicant has found that programing sensor 20A to add about 4 inches to the box length L as determine by the scaler 12 and about 6 inches that when the proximity sensor 20B is triggered works well for most cases.

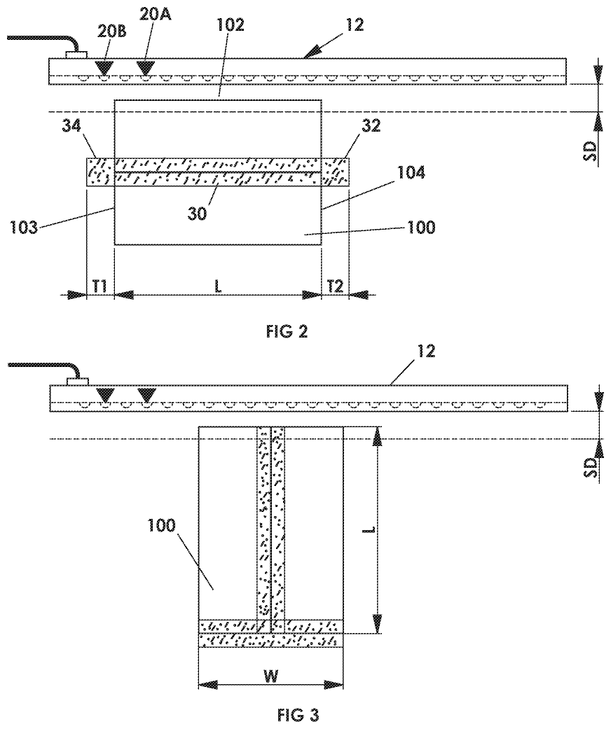

FIG. 2 shows a box of length L being scaled by the scaler 12 and with the special sensor 20A activated to add length to the tape being dispensed to provide added tab lengths T1 and T2 that correspond with the length set to be added when only the sensor 20A is activated. In FIG. 3 where the width W of the box is being scanned and determined by the scaler 12 neither of the special sensors 20A or 20B is activated so no length is added to the tape being dispensed and the length of tape dispensed will be equal to the width W sensed and/or determined by the scaler 12.

A scaling distance SD is identified in FIGS. 2, 3, 5 and 6 which designates the maximum spacing between the box 100 and scaler 12 i.e. proximity sensors 20 at which the sensor 20 will be activated so the box wall 102 (length of box 100) or wall 103 (width of box 100) must be moved substantially perpendicularly to the sensor 12 into the space between the designated scaling distance SD and the adjacent face of the scaler 12 i.e. the sensors 20. The preferred scaling distance SD is set in known manner to about 3 inches.

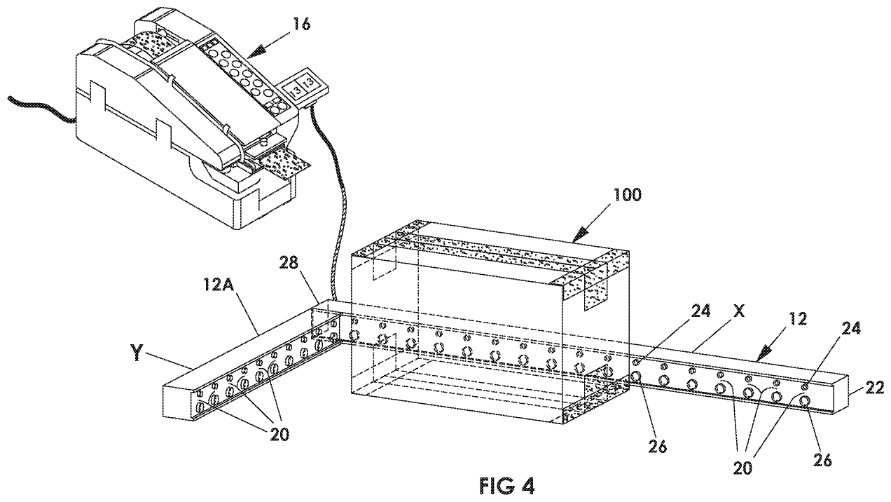

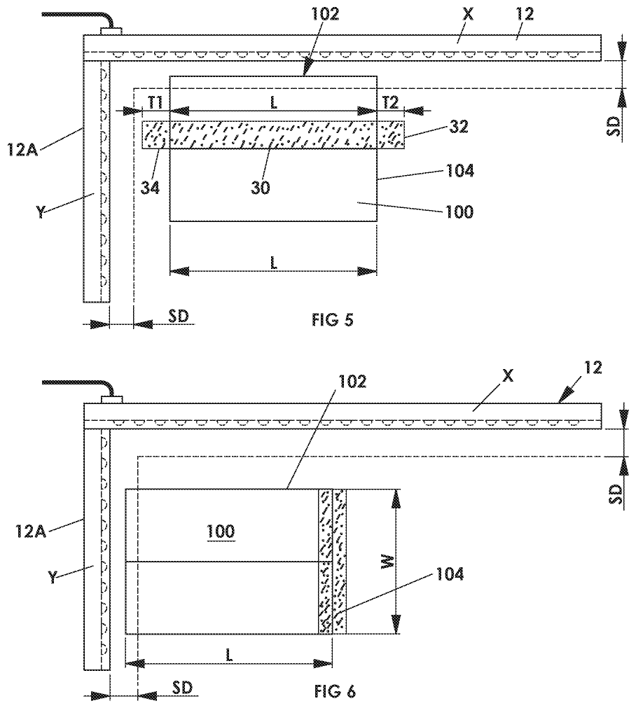

In FIG. 4 a second scaling arrangement is shown and its operation illustrated in FIGS. 5 and 6. In this system a second scaler 12A extends perpendicular to and is positioned adjacent to one end (end 28 in the illustrated arrangement) of the scaler 12. This scaler 12A is constructed in the same the same as scaler 12 but is shorter as it is intended to be used to determine the shorter dimension of the box 100 i.e. the width W. In the illustrated arrangement no special proximity detectors equivalent to 20A and 20B described above are shown in scaler 12A but one or both may be added if desired. Generally, the scaler 12 has been indicated as scaling in the X direction and scaler 12A in the Y direction.

Turning to FIG. 7 the scanning and control system 200 is illustrated. The scanner 12 is show as described above as composed of a plurality of substantially equally space sensor 20 each composed of an IR led (emitter) 24 and an IR sensor (receiver) 26. The microcontroller 50 of the control system 200 controls the shift register 52 via line 54 which operates the IF LEDs 24 and receives the signal output from the IR sensors 26 via line 56 and outputs to a USB host controller 58 via line 60. The host controller sends a signal via line 62 to the tape dispenser 16 control (not shown) to control the operation of the tape dispenser 16.

In operating the invention SD is adjusted as above described to be within about 3″ from the scaler 12 to the surface of the carton. The carton is moved toward the scaled with the adjacent wall 102 of the box 100 reasonably parallel to the bar 22 of the scaler 12.

In the preferred embodiment microprocessor 50 is programed:
to start scanning when at least 3 sensors 20 have been actuated within the scanning zone (within distance SD of the bar 22 as described). This is to ensure the wall 102 of the box 100 is reasonably parallel to the bar 22.
to perform the multiple scans wherein the outputs of all sensors 20 are reviewed to obtain the same measurement reading within a selected number of consecutive scans (Applicant has chosen 20 scans) which will be registered as a confirmed measurement output signal. The use of a number of consecutive scans with identical measurement eliminates the effect of the any undesirable movement of the carton being measured.

The scanning process is normally completed in about 0.5 seconds. The confirmed measurement output signal activates the tape dispenser to dispense the desirable length of tape for tape application.

When the box 100 has been moved out of the sensing zone all the sensors 20 are deactivated and the system reset for the next measurement. Alternatively, the system will be reset after the dispenser dispensed the tape.

It will be apparent how the dispensed tape is applied to the box 10 namely by grasping eh cut tape length adjacent to its ends and moving the tape against the appropriate part of the box and if tabs 32 and 34 are provided rubbing them down against their adjacent ends 103,104 of the box 100.

The embodiment of FIGS. 4, 5 and 6 are operated the same as described but instead of scaling the width W using scaler 12 scaler 12A is used.

It will be apparent that the use if the invention is not limited to boxes the system may be used for dispensing tape lengths for other objects or packages.

Having described the invention, modifications will be evident to those skilled in the art without departing from the scope of the invention as defined in the appended claims.

We claim:

1. A tape dispensing system comprising a tape dispenser, a scaling sensor to determine a dimension of an object to which a length of tape is to be applied said scaling sensor generating scaling signals used to determine said dimension of said object, a control system including a processor processing said scaling signals to determine a tape length to be dispensed and controlling said dispenser to actuate said tape dispenser and dispense said tape length.

2. The tape dispensing system of claim 1 wherein said scaling sensor comprises a support bar mounting a plurality of uniformly spaced interconnected proximity sensors connected to said control system to generate said scaling signal.

3. The tape dispensing system of claim 2 wherein said proximity sensors each includes signal emitter emitting a proximity signal and a receiver for receiving said proximity signal, said signal emitter and said receiver being relatively positioned so that said receiver receives said proximity signal when it is reflected from an adjacent surface of said object when said object is moved into sensing range of said proximity sensor.

4. The tape dispensing system of claim 3 wherein said proximity signal is an infrared light and said receiver is an infrared sensor.

5. The tape dispensing system of claim 2 wherein said support bar s provided with at least one special sensor having an additional function to, when activated, add additional length to said tape length.

6. The tape dispensing system of claim 1 wherein said scaling sensor further includes a second scaling sensor perpendicular to said scaling sensor for determining a second dimension of said object.

7. The tape dispensing system of claim 1 wherein said processor is programed to start scanning when at more than one of said sensors have been actuated and to perform the multiple scans, review outputs of all said sensors to obtain a stable measurement reading based on a plurality of consecutive scans and register such measurement as a confirmed measurement output signal to activate the tape dispenser.

8. The tape dispensing system of claim 2 wherein said processor is programed to start scanning when at more than one of said sensors have been actuated and to perform the multiple scans, review outputs of all said sensors to obtain a stable measurement reading based on a plurality of consecutive scans and register such measurement as a confirmed measurement output signal to activate the tape dispenser.

9. The tape dispensing system of claim 3 wherein said processor is programed to start scanning when at more than one of said sensors have been actuated and to perform the multiple scans, review outputs of all said sensors to obtain a stable measurement reading based on a plurality of consecutive scans and register such measurement as a confirmed measurement output signal to activate the tape dispenser.

10. The tape dispensing system of claim 4 wherein said processor is programed to start scanning when at more than one of said sensors have been actuated and to perform the multiple scans, review outputs of all said sensors to obtain a stable measurement reading based on a plurality of consecutive scans and register such measurement as a confirmed measurement output signal to activate the tape dispenser.

11. The tape dispensing system of claim 5 wherein said processor is programed to start scanning when at more than one of said sensors have been actuated and to perform the multiple scans, review outputs of all said sensors to obtain a stable measurement reading based on a plurality of consecutive scans and register such measurement as a confirmed measurement output signal to activate the tape dispenser.

12. The tape dispensing system of claim 6 wherein said processor is programed to start scanning when at more than one of said sensors have been actuated and to perform the multiple scans, review outputs of all said sensors to obtain a stable measurement reading based on a plurality of consecutive scans and register such measurement as a confirmed measurement output signal to activate the tape dispenser.
